(19) United States
(12) Patent Application Publication
(10) Pub. No.: US 2025/0160428 A1
(43) Pub. Date: May 22, 2025

(54) ELECTRONIC VAPOR PROVISION DEVICE

(71) Applicant: NICOVENTURES TRADING LIMITED, London (GB)

(72) Inventor: Christopher LORD, London (GB)

(21) Appl. No.: 19/029,323

(22) Filed: Jan. 17, 2025

Related U.S. Application Data
(63) Continuation of application No. 18/310,240, filed on May 1, 2023.
Application No. 18/310,240 is a continuation of application No. 14/432,697, filed on Mar. 31, 2015, now Pat. No. 11,647,793.

(30) Foreign Application Priority Data
Oct. 19, 2012 (GB) 1218816.5

(51) Int. Cl. A24F 40/51; A24F 40/10; G01K 1/20; G01L 19/04

(52) U.S. Cl. CPC A24F 40/51; G01K 1/20; G01L 19/04; A24F 40/10

(57) ABSTRACT

An electronic vapor provision device including a power cell and a computer. wherein the computer includes a computer processor, a memory and an input-output means, and wherein the device further includes a pressure sensor and a temperature sensor.

### CLAIM FOR PRIORITY

This application is a Continuation of U.S. application Ser. No. 18/310,240, filed May 1, 2023, which is a Continuation of U.S. application Ser. No. 14/432,697, filed Mar. 31, 2015, now issued as U.S. Pat. No. 11,647,793, which is a National Stage entry of PCT/EP2013/071069, filed Oct. 9, 2013, which claims priority to GB Application No. 1218816.5, filed Oct. 19, 2012, all of which are hereby incorporated by reference in their entirety.

### TECHNICAL FIELD

The specification relates to electronic vapor provision devices. More particularly, but not exclusively, the present specification concerns electronic vapor provision devices such as electronic cigarettes.

### BACKGROUND

Electronic vapor provision devices are typically cigarette-sized and function by allowing a user to inhale a nicotine vapor from a liquid store by applying a suction force to a mouthpiece. Some electronic vapor provision devices have a pressure sensor that activates when a user applies the suction force and causes a heater coil to heat up and vaporize the liquid. Electronic vapor provision devices include electronic cigarettes.

### SUMMARY

An electronic vapor provision device comprising a power cell and a computer, where the computer comprises a computer processor, a memory and an input-output means; wherein the device further comprises a pressure sensor and a temperature sensor.

Having a temperature sensor has the advantage that the device can use temperature readings to provide a more sophisticated device, implementing operations for both control and safety.

Suitably, the electronic vapor provision device is an electronic cigarette.

Suitably, the computer is a microprocessor.

Suitably, the electronic vapor provision device comprises a first end and a second end, where the first end is a mouthpiece end, the second end is a tip end and the temperature sensor is located towards the tip end. Suitably, the computer is located towards the tip end. Suitably, the pressure sensor is located towards the tip end.

By locating the temperature sensor towards the tip end of the device ensures that the sensor is the furthest distance from the mouthpiece end. Typically a vaporizer comprising a heating element is located towards the mouthpiece end so it is advantageous to keep the temperature sensor far away. This ensures that the temperature sensor is not significantly affected by the heat from the heating element, and the temperature sensor can therefore measure ambient environmental temperature more reliably. Also, a liquid store is typically located near the mouthpiece end. So locating the temperature sensor, pressure sensor and computer towards the tip end minimizes the risk of liquid interfering with these components.

Suitably, the temperature sensor is configured in use to measure ambient temperature. Suitably, pressure sensor is configured in use to measure ambient pressure. Suitably, the computer is configured in use to read both pressure and temperature at substantially the same time.

By measuring both the temperature and pressure at substantially the same time, the computer is therefore able to gain a snapshot of these values and allow for any required physical adjustments or compensations.

Suitably, the pressure sensor and temperature sensor form a combined sensor.

Suitably, the combined sensor is a calibrated sensor. Suitably, the calibrated sensor is calibrated for pressure and temperature. Suitably, the calibrated sensor is calibrated for use in atmospheric conditions.

Suitably, the combined sensor is constructed as a single electronic component.

A combined sensor ensures not only that the temperature and pressure are measured at the same time, but also at the same location. This gives a much more accurate determination of these values. A combined unit also has the advantage that only a single unit is needed leading to easier fabrication and a smaller component. Also, by using a sensor that is purposely designed to measure both temperature and pressure at the same time and location, a calibrated sensor can be used that is calibrated especially for this purpose and therefore provides a more accurate reading.

Suitably, the combined sensor is configured in use to determine the temperature and the pressure and provide a pressure reading that is dependent on the temperature.

Suitably, the combined sensor is configured in use to determine the temperature and the pressure and provide a substantially linear relationship between a voltage output and the measured pressure.

Suitably, the computer is configured in use to obtain a temperature reading from the temperature sensor and pressure reading from the pressure sensor and adjust the pressure reading to compensate for the temperature reading.

Since pressure and temperature are related and affect one another, the combined sensor can be used to compensate for changes to pressure for a given temperature. Advantageously, this can be achieved by the combined sensor itself or by the computer.

Suitably, the computer is configured in use to deliver an electrical current to the heating element when a pressure measured by the pressure sensor is reduced below a threshold pressure. Suitably, the computer is configured in use to obtain a temperature reading from the temperature sensor and adjust the threshold pressure based on the temperature reading.

Given that the device is activated by a user sucking on the device and reducing the pressure past a threshold pressure, a correct pressure measurement is essential for accurate use. Thus, allowing for changes to this threshold pressure value allows for a more accurate device.

Suitably, the electronic vapor provision device comprises a control unit and a vaporizer, where the control unit comprises the power cell, the computer, the pressure sensor and the temperature sensor, and the vaporizer comprises a heating element.

Suitably, the device further comprises a liquid store, configured in use to supply liquid to the vaporizer heating element.

Suitably, the computer is configured in use such that the vaporizer vaporizes a predetermined amount of liquid.

Suitably, the computer is configured in use such that the vaporizer vaporizes a predetermined amount of liquid per unit time.

Suitably, the computer is configured in use such that the vaporizer vaporizes substantially the same amount of liquid each time.

Suitably, the computer is configured in use such that the vaporizer vaporizes substantially the same amount of liquid per unit time, each time.

Suitably, the computer is configured in use to obtain a temperature reading from the temperature sensor and adjust the vaporization such that the vaporizer vaporizes substantially the same amount of liquid per unit time, each time.

Suitably, the computer is configured in use to obtain a pressure reading from the pressure sensor and adjust the vaporization such that the vaporizer vaporizes substantially the same amount of liquid per unit time, each time.

Suitably, the computer is configured in use to obtain a temperature reading from the temperature sensor and adjust the heating temperature of the heating element based on the temperature reading.

Suitably, the computer is configured in use to obtain a pressure reading from the pressure sensor and adjust the heating temperature of the heating element based on the pressure reading.

Suitably, the computer is configured in use to obtain a temperature reading from the temperature sensor and adjust an electrical current delivered to the vaporizer based on the temperature reading.

Suitably, the computer is configured in use to obtain a pressure reading from the pressure sensor and adjust an electrical current delivered to the vaporizer based on the pressure reading.

Suitably, the computer is configured in use to reduce the heating power delivered to the heating element as the ambient temperature increases.

The heat output of the heating element is dependent on the starting temperature and the heating power. The vaporization effect also depends on the starting temperature since this affects the viscosity of the liquid being vaporized. By measuring the starting temperature, the heating power can be controlled to provide a consistent heating and vaporization effect.

Suitably, the computer is configured in use to enter a wait mode when the temperature reading exceeds a first threshold temperature. Suitably, the wait mode is a lower power mode compared to a normal operating mode.

Suitably, in wait mode a vaporizer cannot be activated.

Suitably, the computer is configured to remain in wait mode for a predetermined wait time.

Having a wait mode when the temperature gets too hot provides added safety for the user and ensures that the user cannot be harmed.

Suitably, prior to leaving wait mode, the computer is configured in use to measure temperature and then remain in wait mode if temperature is above a second threshold temperature, or leave wait mode if temperature is below a second threshold temperature. Suitably, the first threshold temperature is equal to second threshold temperature.

Suitably, the computer is configured in use to disable the device if temperature measured by the temperature sensor is above a critical threshold temperature. Suitably, the device further comprises a fuse connected to the computer and the device is disabled by blowing the fuse.

If the device has exceed a safe operating temperature where damage to the device could have occurred then it is advantageous to disable to device.

### BRIEF DESCRIPTION OF THE DRAWINGS

For a better understanding of the disclosure, and to show how example embodiments may be carried into effect, reference will now be made to the accompanying drawings in which:

FIG. 1 is a side perspective view of an electronic vapor provision device;

FIG. 2 is a side sectional view through the device of FIG. 1;

FIG. 3 is an exploded side perspective view of an electronic vapor provision device having separated mouthpiece and control unit;

FIG. 4 is a side sectional view through the device of FIG. 3 with connected mouthpiece and control unit;

FIG. 5 is an exploded side perspective view of an electronic vapor provision device having separated mouthpiece, vaporizer and control unit;

FIG. 6 is a side sectional view through the device of FIG. 5 with connected mouthpiece, vaporizer and control unit;

FIG. 7 is an exploded longitudinal sectional view of another embodiment of an electronic vapor provision device similar to that of FIGS. 3 and 4, and that of FIGS. 5 and 6, showing the internal components thereof in greater detail;

FIG. 8 is a sectional view of the electronic vapor provision device of FIG. 7 when assembled; and

FIG. 9 is a schematic circuit diagram of the vapor provision device of FIGS. 7 and 8.

### DETAILED DESCRIPTION

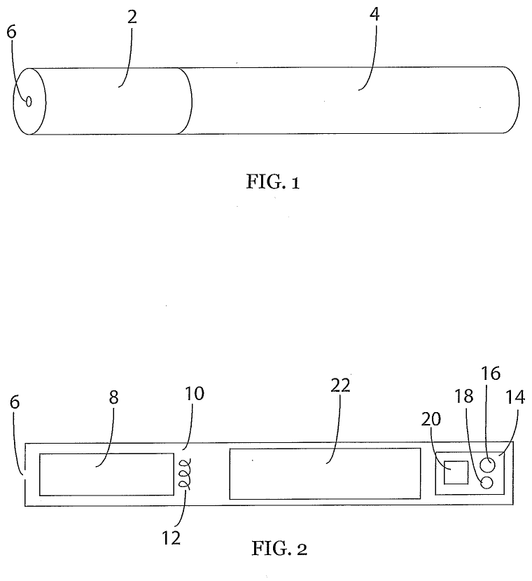

Referring to FIG. 1 and FIG. 2 there is a shown an electronic vapor provision device in the form of a cigarette-shaped electronic cigarette. The electronic vapor provision device has a mouthpiece 2 and a cigarette body 4. The mouthpiece 2 has an air outlet 6 at a first end and is connected to the cigarette body 4 at a second end.

Inside the electronic vapor provision device there is a liquid store 8 towards the mouthpiece end and a vaporizer 10 having a heating coil 12. The vaporizer 10 is arranged next to the liquid store 8 to allow liquid to be transferred onto the vaporizer 10 for vaporizing. A circuit board 14 contains a pressure sensor 16, a temperature sensor 18 and a computer 20. A power cell 22 provides power to the device.

The general operation of the electronic vapor provision device is similar to that of known devices. When a user takes a draw on the electronic vapor provision device, a suction force is applied to the mouthpiece 2 and the air outlet 6. A reduced pressure inside the electronic vapor provision device causes the power cell 22 to provide power to the vaporizer 10 which in turn vaporizes the nicotine liquid solution. The resultant vapor is then inhaled by the user.

In this example the operation of the electronic vapor provision device goes beyond that of a general device. In use, when a user applies a suction force to the electronic vapor provision device, the resultant airflow causes a drop in pressure from ambient pressure to a lower pressure, within the device. The pressure sensor 16 provides a signal to the computer 20. The computer 20 runs software that monitors the pressure signal from the pressure sensor 16 and when it determines that the pressure has been reduced below a threshold pressure, the computer 20 provides an electrical current to the heating coil 12 in order to heat the heating coil 12 and vaporize liquid from the liquid store 8.

The temperature sensor 18 is adjacent the pressure sensor 16 and also provides a temperature signal to the computer 20. The circuit board 14 containing the pressure sensor 16, temperature sensor 18 and computer 20, is located towards the tip of the device. As such, the temperature sensor 18 is located at the furthest possible point from the vaporizer 10 and heating coil 12. This ensures that the temperature sensor 18 acts to measure the ambient temperature and is not affected by the heating coil 12 as it gets hot in use.

The computer 20 receives a signal from the pressure sensor 16 and temperature sensor 18 and is able to determine both the ambient pressure and the ambient temperature at the same time. As such, since a measured pressure is dependent on the temperature at which it is measured, the computer 20 is able to adjust the pressure measurement for the given temperature. In use, the computer is then able to use this adjusted pressure and determine when the adjusted reduced pressure caused by user inhalation passes a threshold pressure value.

Alternatively, the computer 20 can obtain a value for the ambient pressure and ambient temperature and adjust the threshold pressure value to give a compensated threshold pressure. In use, the heating coil 12 is activated when the measured pressure is reduced past the compensated threshold pressure.

The computer 20 is also able to use the temperature reading for other purposes. The ambient temperature affects the vaporization of liquid in two ways. Firstly, the viscosity of the liquid is temperature dependent and therefore the rate at which the liquid flows onto the heating coil 12 and the rate at which vaporization occurs is somewhat dependent on the ambient temperature. Secondly, the temperature the heating coil reaches is dependent on the electrical current or power applied to the coil and also the starting temperature of the coil and the rate at which liquid is transferred to the coil, since vaporization itself removes heat from the coil. The computer 20 is therefore able to measure the ambient temperature and adjust the current and heating power delivered to the coil to compensate for changes in ambient pressure. This therefore provides consistent vaporization regardless of changes in the ambient temperature.

In addition, the computer 20 monitors the ambient temperature reading from the temperature sensor 18 to determine whether the device is safe for a user to operate. If the ambient temperature gets above a first safe threshold temperature then the device can enter a wait mode where the vaporizer is disabled. The device periodically measures the temperature to determine when the ambient temperature is once again safe and fallen below a second safe threshold temperature. The first and second safe threshold temperature can be the same temperature, the first can be higher than the second or the second can be higher than the first. The temperature sensor 18 can also be used to determine when the ambient temperature exceeds a critical safe temperature. This is a temperature that can potentially cause damage to the device rendering it permanently unsafe to use. In this case the device permanently disables the device by blowing a fuse on the circuit board 14.

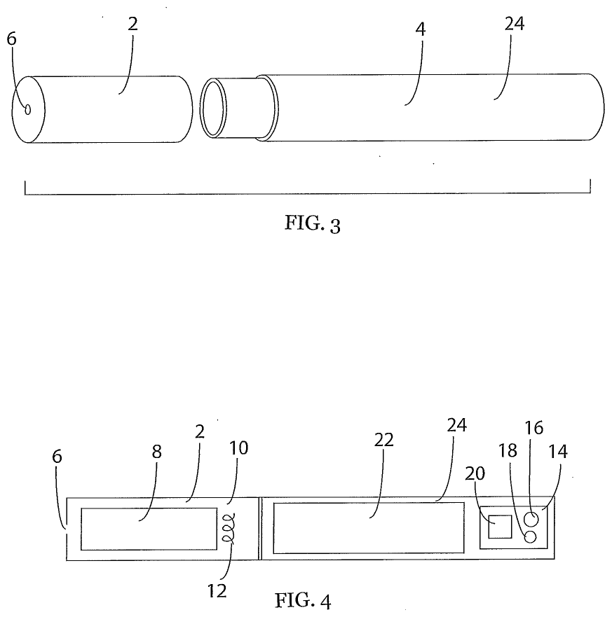

FIG. 3 and FIG. 4 show an electronic vapor provision device similar to that shown in relation to FIG. 1 and FIG. 2. The difference is that the mouthpiece 2 is releasably-attachable to the cigarette body 4. The mouthpiece comprises a female screw thread connection means, the device body 4 is a control unit 24 having a male screw thread connection means. The mouthpiece 2 and the control unit 24 can be screwed together or taken apart.

In this example, the mouthpiece 2 comprises the liquid store 8 and the vaporizer 10 with heating coil 12. The control unit 24 comprises the power cell 22 and circuit board 14 with pressure sensor 16, temperature sensor 18 and computer 20. The screw thread connection provides an electrical connection such that when the mouthpiece 2 and control unit 24 are screwed together, electrical current can be delivered to the heating coil 12 upon activation of the vaporizer 10.

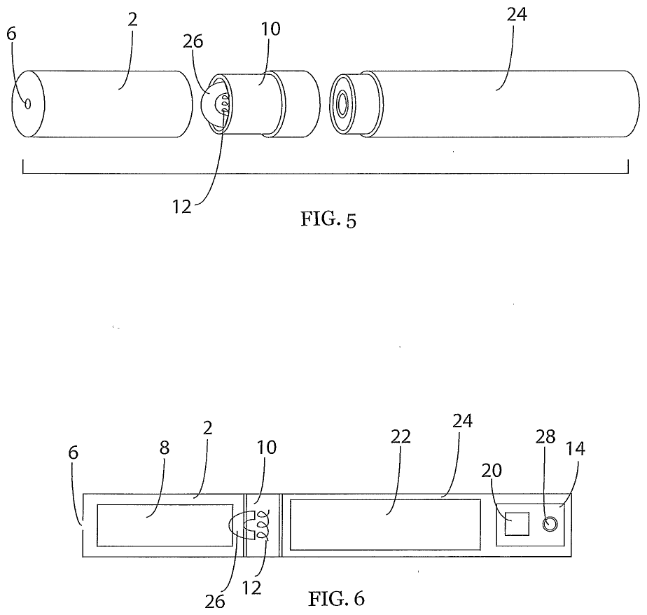

FIG. 5 and FIG. 6 show an electronic vapor provision device similar to that shown in relation to FIG. 3 and FIG. 4. However in this example, the vaporizer 10 is removable from the mouthpiece 2. The mouthpiece 2 has a cylindrical opening that forms an interference push-fit with the vaporizer 10. As such the mouthpiece 2 can be separated from the vaporizer 10. The mouthpiece 2 comprises the liquid store 8. The vaporizer 10 comprises the heating coil 12 and a wick 26. The wick 26 protrudes from the end of the vaporizer 10 such that when the mouthpiece 2 and the vaporizer 10 are connected, the wick 26 dips into the liquid store 8.

In use, as a user inhales on the device, liquid is transferred from the liquid store 8 and onto the wick 26 before being transferred onto the heating coil 12 for vaporization.

The device in this example also differs from previous examples in that the temperature sensor and pressure sensor form a combined sensor 28. Thus the combined sensor 28 is a single electronic component and is connected to the computer. The combined sensor 28 is able to provide simultaneous readings of both temperature and pressure to the computer 20. The combined sensor 28 is a calibrated sensor in that it has been calibrated to provide accurate pressure and temperature signals dependent on one another. As such the sensor itself is able to provide an adjusted pressure reading that compensates for temperature variations.

The pressure sensor 16 and/or the combined pressure and temperature sensor 28, is suitably sufficiently sensitive to be able to operate according to the required parameters described above. In this regard, the sensor may have a sensitivity of around +/−5 Pa, and may have a sensitivity of +/−3 Pa, and more suitably may have a sensitivity of +/−1 Pa. Given that standard atmospheric pressure is in the order of around 100,000 Pa, it is clear that the sensor 16/28 is highly sensitive. The degree of sensitivity may be provided by the hardware used in the sensor itself, and also the compensatory algorithm provided by the sensor which is loaded onto the computer 20. In use, the sensor provides raw pressure data, and raw temperature data may be provided either by the separate temperature sensor 18 or by the combined pressure and temperature sensor 28. This is fed to the computer 20 which calculates the pressure compensated for the temperature. However, in an alternative embodiment, the sensors 16, 18, 28 may comprise an internal microprocessor such that the sensors 16, 18, 28 themselves may be able to provide the compensated reading as a direct output. The temperature and pressure sensor 18, 16, or combined temperature and pressure sensor 28, are also present as a combination, i.e. on one circuit board 14. This is advantageous within an electronic vapor provision device because the temperature profile may vary across such devices for a number of reasons—for example, the heater being on, holding of the device etc. The output from the sensor(s) 16, 18, 28 is also digital, which is advantageous in the context of the device as a whole.

Within the devices described above, temperature can be independently monitored at the same time as providing compensatory data for the pressure reading. This is because the sensor(s) provide raw temperature and pressure outputs. This enables the sensor(s) to also act as a safety component in that it/they can provide information to the computer about the temperature of the device which can then signal a cut-out at certain pre-determined temperatures, for example 50 degrees Celsius.

The compensated pressure reading is also important. For regulatory purposes, it is advantageous that the device does not operate inadvertently—such as when the device is not in the mouth, or even when the device is in the mouth of a user but they are not intentionally inhaling. One way of achieving this is by setting defined pressure thresholds and ensuring that they are not “breached” as a result of a faulty sensor.

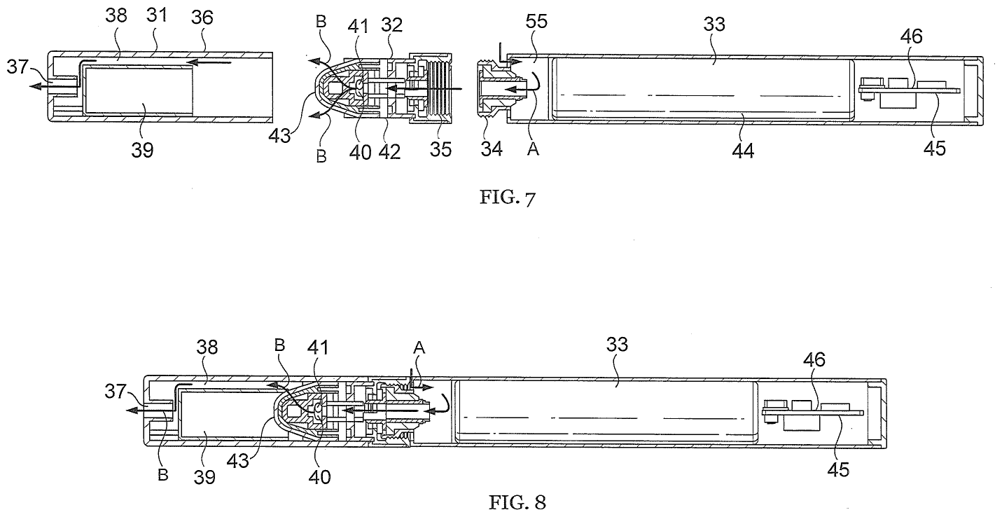

FIGS. 7 and 8 illustrate another embodiment of an electronic vapor provision device in the form of an electronic cigarette. The device is similar to the embodiment shown in FIGS. 3 and 4, and the embodiment shown in FIGS. 5 and 6, although the embodiment in FIGS. 7 and 8 shows the internal components thereof in greater detail. The device comprises a mouthpiece 31, vaporizer device 32 and control unit 33 which can be assembled as shown in FIG. 8 to provide a generally cylindrical device that can be used as a substitute for a conventional tobacco burning cigarette. The control unit 33 is provided with a threaded extension 34 that is received in an interior thread 35 in the vapor device 32. The mouthpiece 31 comprises a generally cylindrical plastics casing 36 that can be push-fitted on to the vapor device 32.

The mouthpiece 31 has an outlet 37 to supply vapor to the mouth of the user and an outlet passageway 38 for the vapor which, in use is produced by the vapor device 32. The mouthpiece 31 also includes a liquid reservoir comprising a porous storage matrix 39 such as plastics open foam material impregnated with a vaporizable liquid, such as a nicotine containing liquid that in use is vaporized by the vapor device 32. The matrix 39 acts as a reservoir for the liquid and since the mouthpiece 31 is readily removable and replaceable, it can be used as a refill capsule when the liquid in the porous matrix 39 becomes depleted and needs to be replenished.

The vapor device 32 includes an electronic heating coil 40 that is wound around a ceramic core 41, supported on a ceramic base 42. A generally U-shaped wicking member 43 is configured to wick liquid from the reservoir 39 towards the heating element 40 by capillary action. The wicking member 43 may for example by made of a metallic foam such as nickel foam.

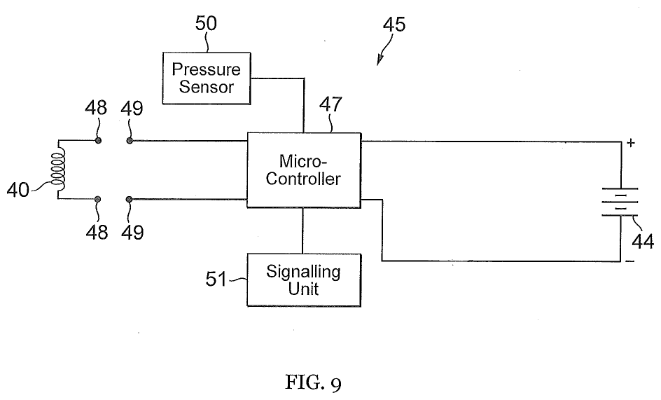

The heater coil 40 is powered by a rechargeable battery 44 located in the control unit 33 through electrical contacts 48, 49 (not shown in FIGS. 7 and 8, see FIG. 9) which electrically couple the heater coil to the battery 44 when the control unit 33 is fitted to the vapor device 32 by the engagement of threads 34, 35. The electrical power of the battery 44 is supplied to the heater coil 40 under the control of a control circuit 45 mounted on circuit board 46 within the control unit 33.

As shown in FIG. 9, the control circuit 45 includes a micro controller 47 powered by battery 44 to supply an electric heating current to the coil 40 through the contacts 48, 49 that are brought into electrical connection when the control unit 33 is threadedly engaged with the vapor device 32 by means of threads 34, 35 shown in FIG. 7.

A pressure sensor 50 detects when a user draws on the mouthpiece 38, as described in more detail hereinafter.

Also, a signaling unit 51 is provided to provide audio or visual outputs to the user indicative of operational conditions of the device. For example, the signaling device may include a light emitting diode that glows red when the user draws on the device. The signaling device may provide predetermined audio or visual signals to indicate for example that the battery 44 needs to be recharged.

The supply of current from the battery 44 to the mouth controller is controlled by switching transistor 52.

When the user draws on the mouthpiece 1 so as to draw vapor through the outlet 37, the pressure sensor 50 detects the drop in pressure which is communicated from within the vapor device 32 through the interior of the control unit 33 to the circuit board 45. Microcontroller 47 responds to the pressure drop detected by the sensor 50 to supply electrical current to the heater coil 40, which vaporizes liquid supplied by capillary action through the U-shaped wicking member 43. An air inlet passageway 55 is provided in the joint between the vapor unit 32 and control unit 33 so that air can be drawn through the threaded extension 34 of the control unit 33 into the vapor device 32 in the direction of arrows A, so that the resulting vapor is drawn in the direction of arrows B through passageway 38 to the outlet 37.

The operation of the device of FIGS. 7 and 8 may be the same as that of the devices of FIGS. 1 to 6 described previously and so a detailed description of such operation will not be repeated here. However, it is intended that the control circuit 46 of the embodiment of FIGS. 7 and 8 may be configured as per the circuit board 14 of the embodiments of FIGS. 1 to 6, and vice versa. Specifically, the circuit board 46 may comprise a temperature sensor 18, or a combined temperature and pressure sensor 28. Also, the pressure sensor 50 may be disposed on the circuit board 46 within the control unit 33 and the vapor device 32 may be in fluid communication with the area within the control unit 33, via an open passageway for example (not shown), such that a drop in pressure within the vapor device 32 is detectable by a pressure sensor on the circuit board 46 within control unit 33. Also, the microcontroller 47 of the embodiment of FIGS. 7 and 8 may be programmed as per the computer 20 of the embodiment of FIGS. 1 to 6 to monitor both measured temperature and pressure from the sensor(s) to control the device accordingly and as described previously.

Although examples have been shown and described it will be appreciated by those skilled in the art that various changes and modifications might be made without departing from the scope of the invention. The computer processor could be a microprocessor or a microcontroller. The device is not restricted to being cigarette shaped. The computer processor, temperature sensor and pressure sensor are not restricted to being on the same circuit board. The heating coil used for vaporization could be replaced by another type of non-coil heating element.

In order to address various issues and advance the art, the entirety of this disclosure shows by way of illustration various embodiments in which the claimed invention(s) may be practiced and provide for superior electronic vapor provision devices. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future. Any feature of any embodiment can be used independently of, or in combination with, any other feature.

1. An electronic vapor provision device comprising a power cell, a heating element, and a computer, where the computer comprises a computer processor, a memory and an input-output means; wherein the device further comprises a temperature sensor, wherein the computer is configured in use to enter a wait mode when the temperature reading exceeds a first threshold temperature.

2. The electronic vapor provision device of claim 1, wherein the electronic vapor provision device is an electronic cigarette.

3. The electronic vapor provision device of claim 1, wherein the computer is a microprocessor.

4. The electronic vapor provision device of claim 1, wherein the electronic vapor provision device comprises a first end and a second end, where the first end is a mouthpiece end, the second end is a tip end and the temperature sensor is located towards the tip end.

5. The electronic vapor provision device of claim 4, wherein the computer is located towards the tip end.

6. The electronic vapor provision device of claim 1, wherein the temperature sensor is configured in use to measure ambient temperature.

7. The electronic vapor provision device of claim 1, wherein the device further comprises a pressure sensor configured in use to measure ambient pressure.

8. The electronic vapor provision device of claim 7, wherein the computer is configured in use to read both pressure and temperature at substantially the same time.

9. The electronic vapor provision device of claim 7, wherein the pressure sensor and temperature sensor form a combined sensor.

10. The electronic vapor provision device of claim 9, wherein the combined sensor is constructed as a single electronic component.

11. The electronic vapor provision device of claim 9, wherein the combined sensor is configured in use to determine the temperature and the pressure and provide a pressure reading that is dependent on the temperature.

12. The electronic vapor provision device of claim 7, wherein the computer is configured in use to deliver an electrical current to the heating element when a pressure measured by the pressure sensor is reduced below a threshold pressure.

13. The electronic vapor provision device of claim 12, wherein the computer is configured in use to obtain a temperature reading from the temperature sensor and adjust the threshold pressure based on the temperature reading.

14. The electronic vapor provision device of claim 1, wherein the electronic vapor provision device comprises a control unit and a vaporizer, where the control unit comprises the power cell, the computer and the temperature sensor, and the vaporizer comprises the heating element.

15. The electronic vapor provision device of claim 1, wherein the wait mode is a lower power mode compared to a normal operating mode.

16. The electronic vapor provision device of claim 1, wherein in the wait mode the heating element cannot be activated.

17. The electronic vapor provision device of any claim 1, wherein the computer is configured to remain in the wait mode for a predetermined wait time.

18. The electronic vapor provision device of claim 1, wherein prior to leaving the wait mode, the computer is configured in use to measure temperature and then remain in the wait mode if temperature is above a second threshold temperature, or leave the wait mode if temperature is below a second threshold temperature.

19. The electronic vapor provision device of claim 18, wherein the first threshold temperature is equal to second threshold temperature.

20. The electronic vapor provision device of claim 1, wherein the computer is configured in use to disable the device if the temperature reading measured by the temperature sensor is above a critical threshold temperature.
